(19) United States
(12) Patent Application Publication
(10) Pub. No.: US 2007/0145740 A1
(43) Pub. Date: Jun. 28, 2007

(54) Connection assembly for pneumatic tools

(76) Inventor: Wuu-Cheau Jou, Dali City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/316,222

(22) Filed: Dec. 22, 2005

(51) Int. Cl. F16L 27/04

(52) U.S. Cl. 285/261

(57) ABSTRACT

A connection assembly for pneumatic tool includes a first connector connected to the pneumatic tool and a spring is received in the passage so as to bias a seal member received in the passage. A nut is connected to the first connector and a sphere of a second connector is engaged with a chamber defined in the nut. The second connector includes an axial passage defined therethrough. The second connector can be rotated 360 degrees and tilted an angle relative to the nut. The seal member is in contact with the sphere by the spring so as to prevent leakage.

### FIELD OF THE INVENTION

The present invention relates to a connection assembly for pneumatic tools and the hose connected with the connection assembly can be rotated 360 degrees without leakage.

### BACKGROUND OF THE INVENTION

A conventional pneumatic blower 11, a conventional pneumatic grinding tool 12 and a conventional pneumatic spray 13 are shown in FIGS. 4, 5 and 6. Each of the pneumatic tools includes a male connector 15 engaged with an air entrance 14 defined in a handle portion thereof so that a female connector 17 can be quickly connected to the male connector 17. An air hose 16 has one end connected with the female connector 17 and the other end of the hose 16 is connected with an air compressor which is not shown so as to provide pressurized air into the pneumatic tool. However, the users have to adjust the hose 16 frequently during operating the pneumatic tool or the hose 16 might be twisted or tangled by objects.

As shown in FIGS. 8 and 9, an improved connection assembly 20 for the pneumatic tools is provided and can be rotated 360 degrees. The connection assembly 20 includes a first connector 21 which is connected to the pneumatic tool and a nut 22 is connected to an end of the first connector 21. The nut 22 includes a chamber and a seal 24 is engaged with an inner periphery of the chamber. A second connector 23 includes a sphere 231 at a first end thereof and a second end of the second connector 23 is to be connected with a hose which is not shown. The sphere 231 is inserted into the chamber and an outer periphery of the sphere 231 is in contact with the seal 24. The second connector 23 can be rotated 360 degrees and pivoted an angle relative to the nut 22. However, as shown in FIGS. 10 and 11, the sphere 231 is in contact with the seal 24 only at the position where the sphere 231 is located at the lowest position in the chamber of the nut 22. When the sphere 231 is pivoted an angle or is inserted upward, there is a small gap defined between the seal 24 and the outer periphery of the sphere 231, and leakage happens. Besides, the seal 24 gradually wears out after frequent pivotable movement of the sphere 231.

Another improved connection assembly 30 is disclosed in FIGS. 12 to 14, wherein the first connector 31 is connected to the pneumatic tool and the nut 32 with a chamber is threaded to the first connector 31. The sphere 331 of the second connector 33 is accommodated in the chamber and located between two seals 341, 342. Nevertheless, the seal 341 is easily deformed by the first connector 31 when assembling the nut 32 to the first connector 31. Besides, the two seal 341, 342 are in contact with the sphere 331 by only two respective circles which provide limited area to prevent leakage. The conventional connection assemblies 20, 30 are up to 55-60 mm in length which is too long for the pneumatic tools.

The present invention intends to provide a connection assembly for pneumatic tools wherein the sphere is compressed by a sealing member which is biased by a spring to ensure liquid or air tight of the connection.

### SUMMARY OF THE INVENTION

The present invention relates to a connection assembly for pneumatic tools wherein the connection assembly comprises a first connector connected to the pneumatic tool and having a passage defined axially therethrough. A spring and a seal member are received in the passage, and the seal member is biased by the spring. A nut is connected to the first connector and has a chamber defined in a first end thereof. A second connector has a sphere and an axial passage is defined through the second connector. The sphere is engaged with the chamber of the nut and the seal member is in contact with the sphere by the spring.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the connection assembly of the present invention;

FIG. 2 is a cross sectional view to show the connection assembly of the present invention;

FIG. 3 is a cross sectional view to show the connection assembly of the present invention, wherein the second connector is tilted an angle;

FIG. 4 is a conventional pneumatic air blower;

FIG. 5 is a conventional pneumatic grinding tool;

FIG. 6 is a conventional pneumatic spray air blower;

FIG. 7 shows a hose with a female connector is to be connected to a male connector on the pneumatic tool;

FIG. 8 is an exploded view to show a conventional connection assembly with a rotatable second connector;

FIG. 9 shows the second connector in FIG. 8: is rotatable relative to the first connector;

FIG. 10 shows that the second connector in FIG. 8 is tilted an angle;

FIG. 11 shows that the second connector in FIG. 8 is pushed upward;

FIG. 12 shows another conventional connection assembly with a rotatable second connector;

FIG. 13 shows that the second connector in FIG. 12 is rotatable relative to the first connector, and

FIG. 14 shows that the second connector in FIG. 12 is tilted an angle relative to the first connector.

### DETAILED DESCRIPTION OF THE PREFERRED EMBODIMENT

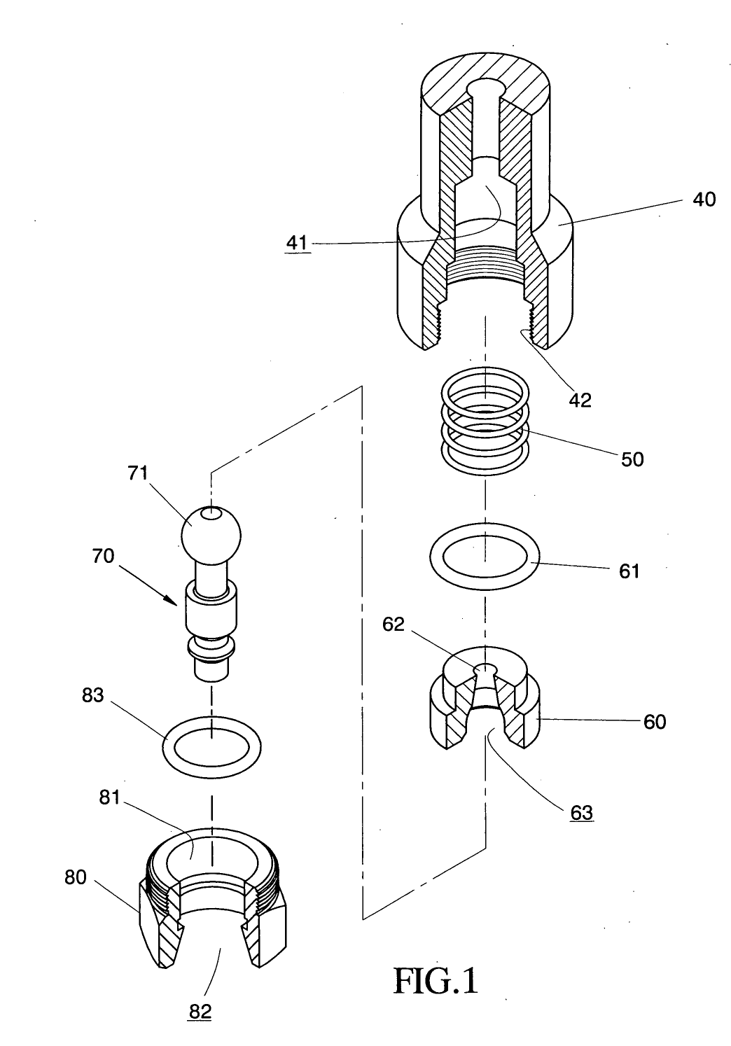

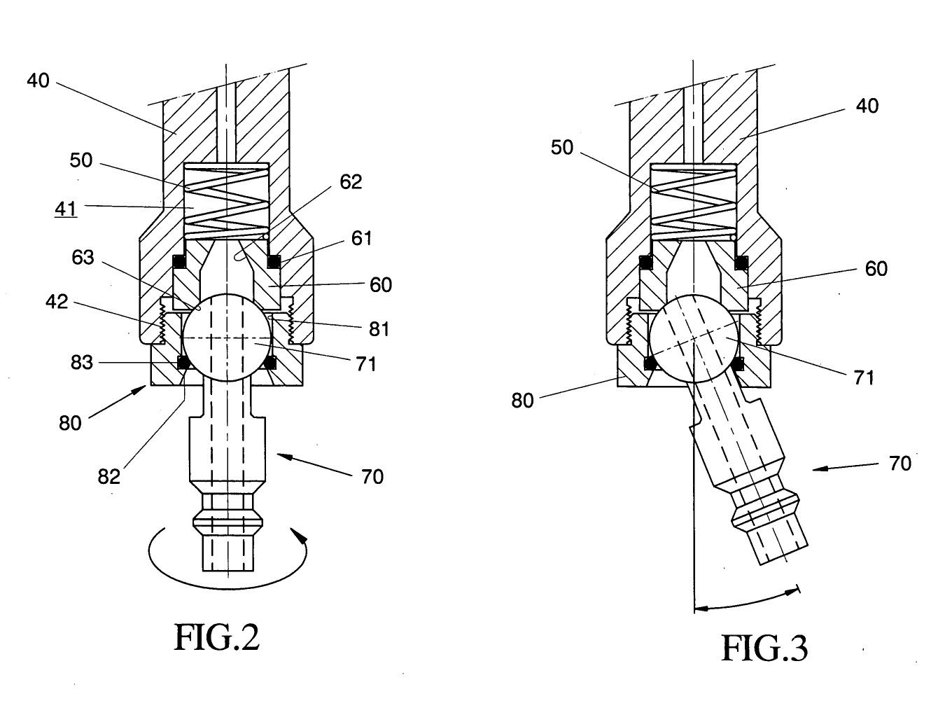

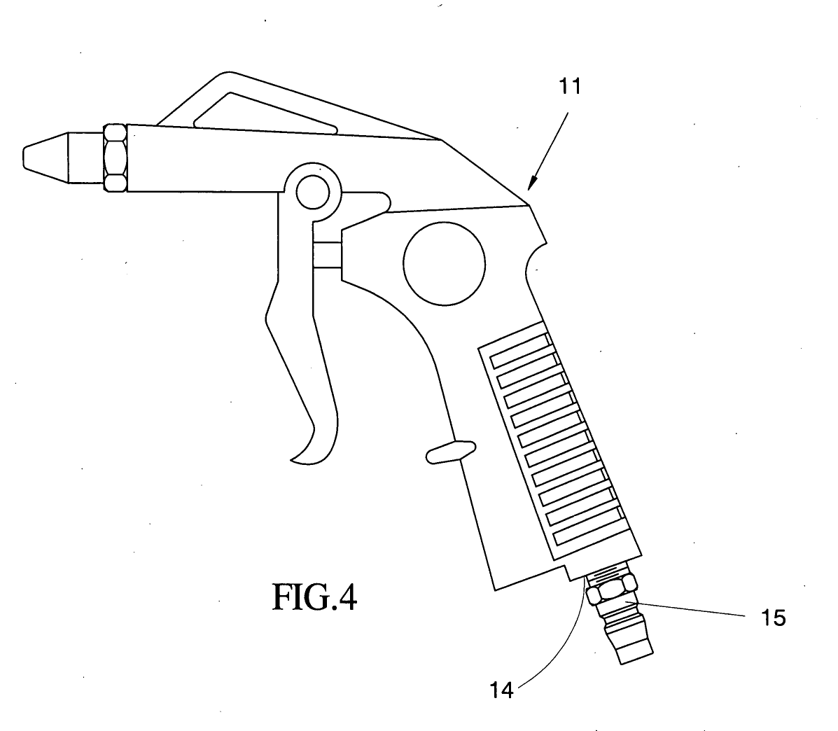

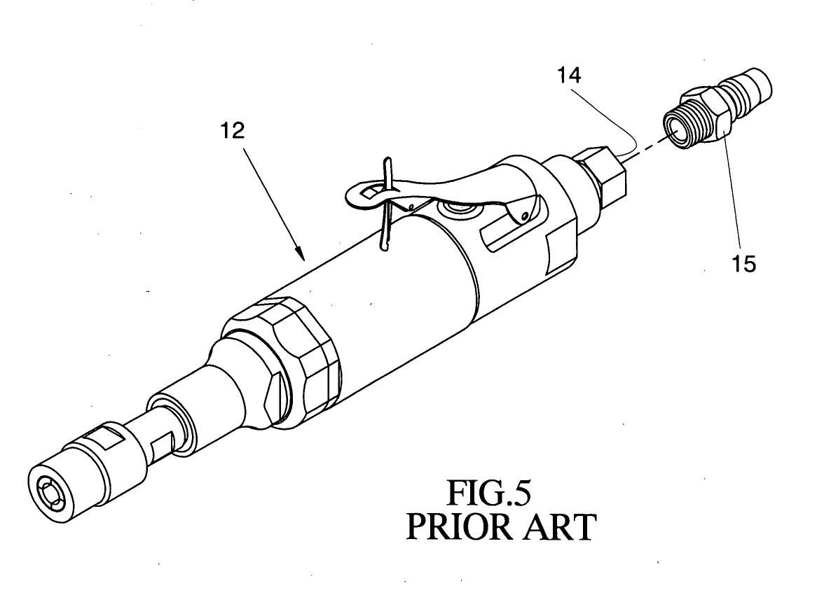

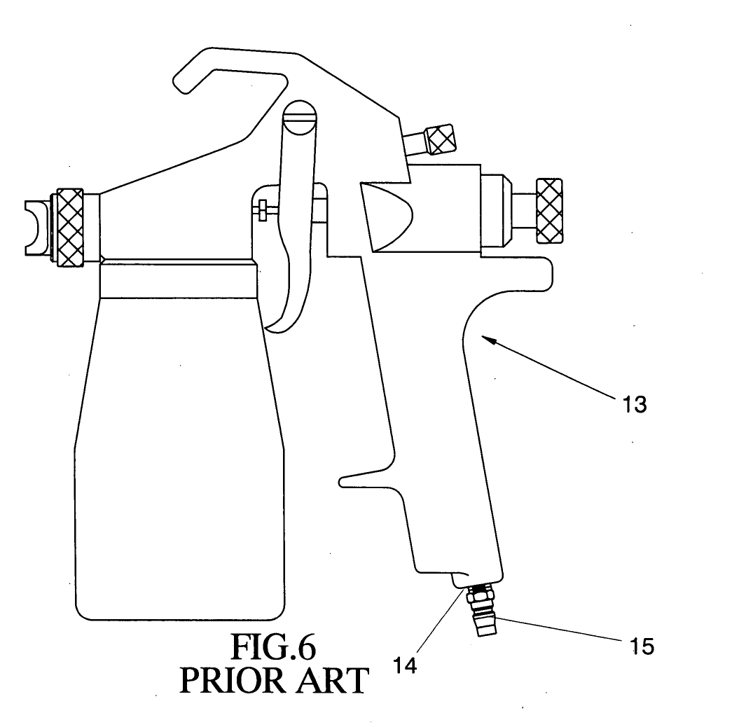

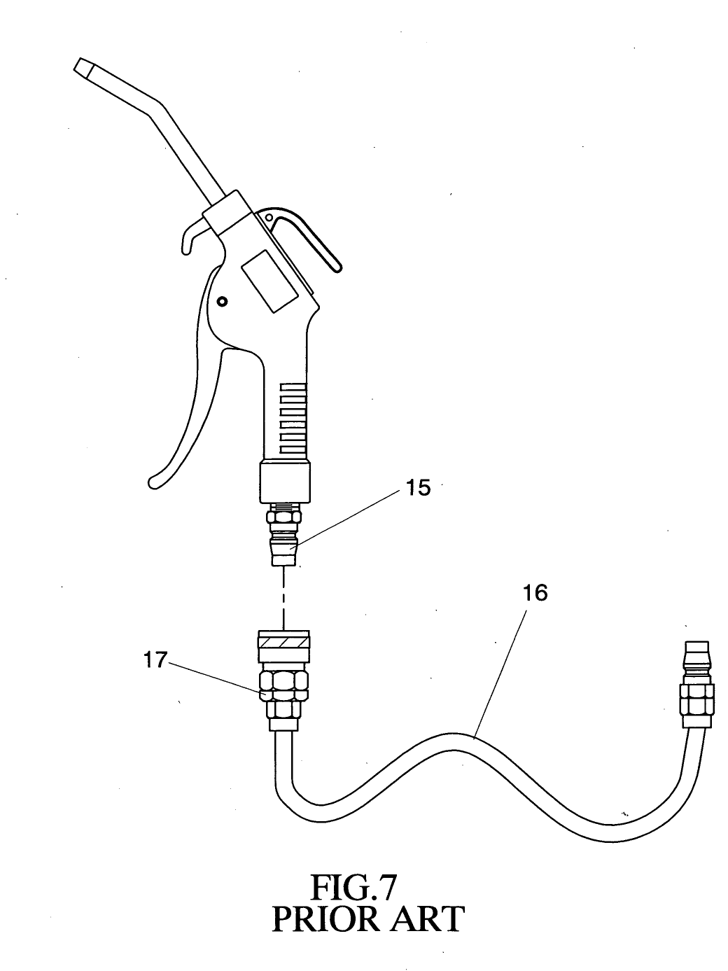

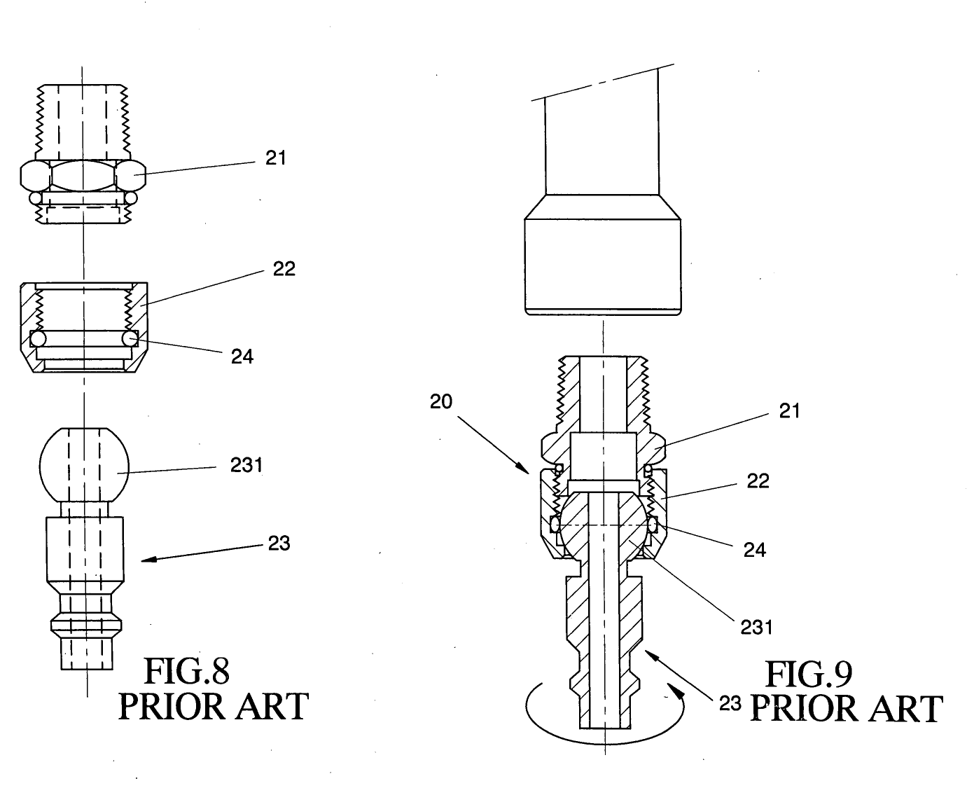

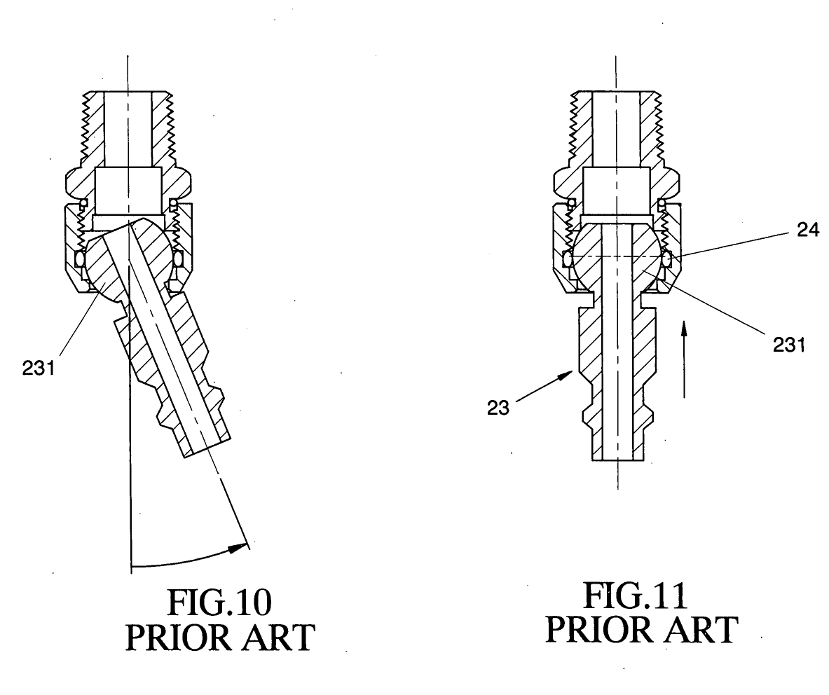

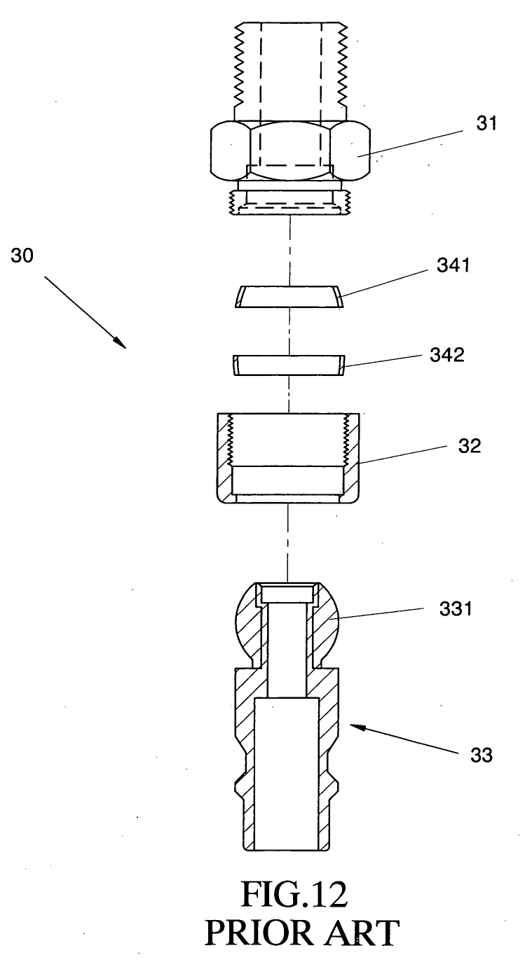

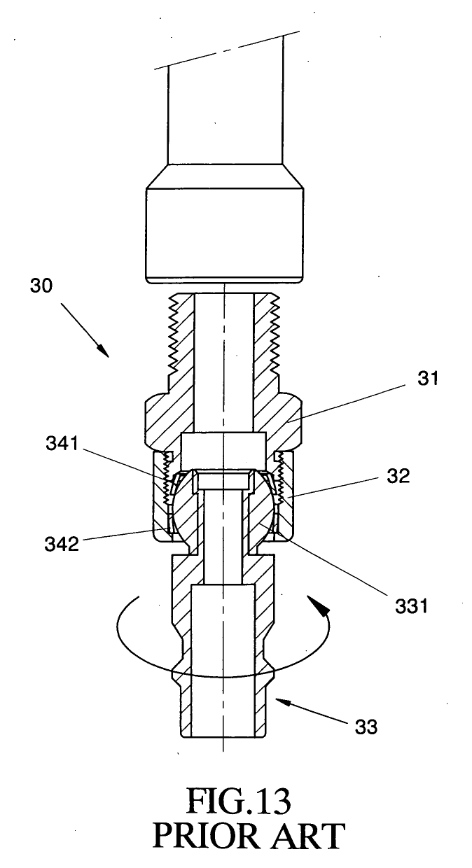

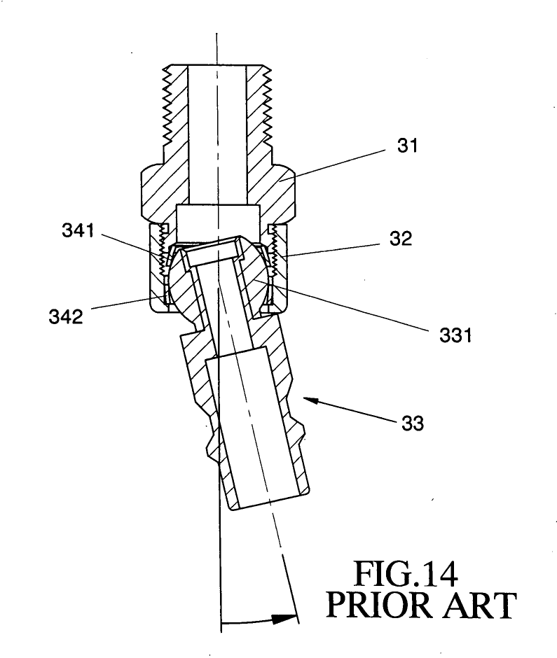

Referring to FIGS. 1 to 3, the connection assembly for pneumatic tools of the present invention comprises a first connector 40 which is connected to the pneumatic tool (not shown) and has a passage defined axially therethrough. A spring 50 and a seal member 60 are received in the passage, and the seal member 60 is biased by the spring 50. A threaded inner periphery 42 is defined in a lower end of the first connector 40. The seal member 60 includes a neck extending from a top thereof and a first seal ring 61 is mounted on the neck. The seal member 60 includes a through hole 62 defined axially therethrough and an enlarged opening is defined in an underside of the seal member 60. The enlarged opening includes an annular concavity 63.

A nut 80 is threadedly connected to the threaded inner periphery 42 of the first connector 40 and has a chamber 81 defined in a first end thereof. The chamber 81 of the nut 80 has a circular inner periphery. The nut 80 includes a tapered opening 82 is defined in a second end thereof and a second seal ring 83 is engaged with an inner periphery of the tapered opening 82 and located at a conjunction area of the chamber 81 and the tapered opening 82 of the nut 80.

A second connector 70 having a sphere 71 and an axial passage is defined through the second connector 70. The sphere 71 is engaged with the chamber 81 of the nut 80 and the seal member 60 is in contact with the sphere 71 by the spring 50. The sphere 71 is engaged with the annular concavity 63 of the seal member 60 so as to maintain the air-tight status between the sphere 71 an the seal member 60.

The seal member 60 is pushed by the spring 50 and the pressure of the air in the passage of the first connector 40 so that the seal member 60 is always in contact with the sphere 71. The second seal ring 83 is located so that which angle the second connector 70 is tilted, the second seal ring 83 seals between the sphere 71 and the chamber 81. The sphere 71 of the second connector 70 is directly connected within the pneumatic tool so that the users simply connects the hose to the second connector 70 to use the pneumatic tool.

While we have shown and described the embodiment in accordance with the present invention, it should be clear to those skilled in the art that further embodiments may be made without departing from the scope of the present invention.

What is claimed is:

1. A connection assembly comprising:
a first connector having a passage defined axially therethrough and a spring received in the passage, a seal member received in the passage and biased by the spring;
a nut connected to the first connector and having a chamber defined in a first end thereof, and
a second connector having a sphere and an axial passage defined through the second connector, the sphere being engaged with the chamber of the nut and the seal member being in contact with the sphere by the spring.

2. The connection assembly as claimed in claim 1, wherein the seal member includes a neck extending from a top thereof and a first seal ring is mounted on the neck.

3. The connection assembly as claimed in claim 1, wherein the seal member includes a through hole defined axially therethrough and an enlarged opening defined in an underside of the seal member.

4. The connection assembly as claimed in claim 3, wherein the enlarged opening includes an annular concavity and the sphere is engaged with the annular concavity of the seal member.

5. The connection assembly as claimed in claim 1, wherein the chamber of the nut has a circular inner periphery for receiving the sphere.

6. The connection assembly as claimed in claim 1, wherein the nut includes a tapered opening defined in a second end thereof and a second seal ring is engaged with an inner periphery of the tapered opening.

7. The connection assembly as claimed in claim 6, wherein the second seal ring is located at a conjunction area of the chamber and the tapered opening of the nut.
